(19) United States
(12) Patent Application Publication
(10) Pub. No.: US 2025/0180400 A1
(43) Pub. Date: Jun. 5, 2025

(54) ARRANGEMENT FOR LASER PROTECTION

(71) Applicants: TRUMPF Lasersystems for Semiconductor Manufacturing GmbH, Ditzingen (DE); TRUMPF Laser GmbH, Schramberg (DE)

(72) Inventors: Helge Hoeck, Empfingen (DE); Fabian Werner, Dunningen (DE); Jürgen Doettling, Schramberg (DE); Markus Graf, St. Georgen (DE); Matthias Hartmann, Schramberg (DE); Sergej Jazuk, Rottweil (DE); Ullrich Weisshaar, Villingen- Schwenningen (DE); Martin Lambert, Korb (DE); André Anguita Lorenz, Neuhausen (DE)

(21) Appl. No.: 19/047,668

(22) Filed: Feb. 7, 2025

Related U.S. Application Data
(63) Continuation of application No. PCT/EP2023/071743, filed on Aug. 4, 2023.

(30) Foreign Application Priority Data
Aug. 12, 2022 (DE) 10 2022 120 482.0

(51) Int. Cl. G01J 1/42; G01J 1/44

(52) U.S. Cl. CPC G01J 1/4257; G01J 1/44

(57) ABSTRACT

An arrangement for laser protection includes a reflecting and/or absorbing optical element configured to be irradiated by a laser beam, and a sensor having a substrate and a meandering electrical first conductor track arranged on a first side of the substrate. The sensor is arranged indirectly or directly on the optical element or configured to detect a damage to the optical element by the laser beam.

### CROSS REFERENCE TO RELATED APPLICATIONS

This application is a continuation of International Application No. PCT/EP2023/071743 (WO 2024/033274 A1), filed on Aug. 4, 2023, and claims benefit to German Patent Application No. DE 10 2022 120 482.0, filed on Aug. 12, 2022. The aforementioned applications are hereby incorporated by reference herein.

### FIELD

Embodiments of the present invention relate to an arrangement for laser protection, and to a laser protection system.

### BACKGROUND

Arrangements for protection from laser beams, for example, in the event of an incorrect alignment of the laser beams, are known from the prior art.

WO2015/172816A1 discloses temperature sensors which are connected to a temperature monitoring unit in order to monitor the correct alignment of the laser beam during the passage through openings.

A laser protection window is known from EP 2 119 531 A1, in which sensors detect secondary radiation generated by laser beams in the laser protection window.

EP 2 338 635 B1 discloses a laser protection wall designed to detect sound induced by a laser beam in the laser protection wall.

DE 20 2016 008 509 U1 relates to a rolling gate of a building opening having a sensor for detecting laser radiation.

Optical elements can have laser beams, in particular short pulse laser beams, shine through them and can thus be destroyed without the optical elements heating up in this case. In many such cases, a destruction of an optical element and a subsequent undesired beam direction of the laser beam is not detected by the sensors used for detecting laser beams at optical elements, which are typically based on a temperature measurement.

### SUMMARY

Embodiments of the present invention provide an arrangement for laser protection. The arrangement includes a reflecting and/or absorbing optical element configured to be irradiated by a laser beam, and a sensor having a substrate and a meandering electrical first conductor track arranged on a first side of the substrate. The sensor is arranged indirectly or directly on the optical element or configured to detect a damage to the optical element by the laser beam.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows schematically shows a laser protection system;

FIG. 2 shows schematically shows a cross section through a detection area of a sensor of the laser protection system;

FIG. 3 shows schematically shows a top view of the substrate and the conductor tracks of the sensor;

FIG. 4 shows a cross section through the sensor.

### DETAILED DESCRIPTION

Embodiments of the present invention provide an arrangement for protection from laser radiation which reliably detects shining through an optical element, in particular if the optical element does not heat up significantly upon the shining through. Embodiments of the invention also provide a laser protection system having such an arrangement.

The arrangement according to embodiments of the invention comprises the following elements:
a) a reflecting and/or absorbing optical element, which can be irradiated by a laser beam;
b) a sensor having a substrate and a meandering electrical first conductor track, which is arranged on a first side of the substrate;
wherein the sensor is arranged indirectly on the optical element or is arranged directly on the optical element or is designed to detect damage to the optical element by the laser beam.

The sensor can be used to establish in a reliable manner whether the laser beam irradiates undesired points in the surroundings of the optical element, for example, whether the laser beam penetrates the optical element. As a result of the detection, the laser beam can be switched off to prevent further damage. The sensor is advantageously compactly formed and has a simple structure.

Due to its meandering guidance, the conductor track is designed to cover a comparatively large proportion of the surface of the substrate. Upon incidence of the laser beam on the conductor track, a part of the conductor track is removed or destroyed. In particular, melting, blasting, or vaporizing of a part of the conductor track takes place. The electrical parameters, in particular the electrical resistance, of the conductor track thus change. If a current flows through the conductor track, a change of these parameters which is outside a predetermined monitoring range can be detected and the laser can be switched off before it causes damage in the surroundings of the optical element. In particular, an interruption of the current flow as a result of a destruction of the conductor track by the laser beam can be detected easily and reliably as a sudden increase of a resistance of the conductor track. The detection of the laser beam advantageously takes place independently of temperature measurements. Switching the laser beam on again is preferably prevented.

Adjacent sections of the conductor track preferably have a sufficiently large spacing that if a point of the conductor track is expanded by the laser beam, for example, by melting, the adjacent sections of the conductor track are not connected to one another. In some embodiments, multiple sensors are connected in series.

The optical element is designed in particular as a mirror, beam guiding tube, and/or aperture. The laser beam is generated in a laser source. This laser source in particular comprises a solid-state laser for generating a laser beam, preferably at a wavelength of 1030 nm. The substrate is in particular designed as a non-carbonizing substrate, for example, made of ceramic. The sensor preferably forms part of a detector unit, in particular of a safety circuit.

The conductor tracks are preferably arranged on the substrate by vapour depositing, squeegeeing, etching, and/or adhesive bonding (inter alia, using a carrier film), wherein in particular additional electrically insulating layers are used in the application method in the case of electrically conductive substrates.

In an advantageous embodiment of the arrangement, the sensor comprises a meandering electrical second conductor track, wherein the first conductor track and the second conductor track are in particular perpendicular to one another. The second conductor track covers additional sections on the surface of the substrate which are not covered by the first conductor track. The probability that a laser beam which is incident on the surface of the substrate also irradiates a conductor track is thus increased. The probability of the detection of the laser beam by the sensor is thus increased.

The second electrical conductor track is arranged in one preferred embodiment on a second side of the substrate, which is opposite to the first side of the substrate. The conductor track on one side of the substrate is thus better protected when the conductor track on the other side of the substrate is subject to a damaging effect, in particular by the laser beam. Furthermore, the sensor is flexibly usable with respect to its alignment.

The first conductor track and the second conductor track are connected in parallel to one another in an advantageous variant. In this embodiment, it can be detected on which side of the substrate a laser beam strikes or whether the laser beam penetrates the substrate. In particular, both conductor tracks can be contacted independently of one another by a detector unit. The sensor is designed having two channels in this case.

Embodiments of the arrangement in which the first conductor track and the second conductor track are connected in series also fall within the scope of the invention. In this case, the sensor is designed having one channel. The change of the electrical parameters of the conductor track at a point of the conductor track results in a change of the electrical parameters of the entire sensor. The detection reliability is thus increased. In particular, an interruption of the current flow at a point of the conductor track results in an interruption of the current flow in the entire sensor.

In one preferred embodiment, the sensor is arranged or formed directly on the optical element, wherein in particular the substrate is formed as a part of the optical element. The arrangement for laser protection is thus made compact and can be easily transported.

The sensor advantageously comprises a housing which encloses at least the first conductor track and the substrate. The housing preferably encloses both above-mentioned conductor tracks and the substrate of the sensor. The housing preferably comprises aluminium as a material. A housing comprising aluminium as a material has the advantage that it can be easily processed and is comparatively cost-effective. The housing can also comprise copper as a material. This has the advantage that the housing is robust, in particular with respect to radiation having a wavelength of 1030 nm. The housing prevents the laser beam from penetrating the sensor, even if it shines through the substrate. Furthermore, the housing is used to mount the remaining components of the sensor. The housing comprises protective glass in some embodiments, in order to reduce the risk that particles, which are created upon irradiation of the sensor by a laser beam, will flow into the surroundings of the sensor. The protective glass is in particular designed for transmission of an employed laser radiation.

A laser protection system according to embodiments of the invention comprises an above-mentioned arrangement for laser protection and a laser source for emitting the laser beam, wherein the optical element is arranged in the beam path of the laser beam. In such a laser protection system, it can be reliably detected by the sensor whether the laser penetrates the optical element or is reflected by the optical element at an undesired point. The laser source is in particular designed to generate laser pulses (for example, short pulses or ultrashort pulses). The sensor is preferably connected for signalling to the laser source in order to switch off the laser source in the event of a specified sensor signal (in the event of specified changes of the electrical parameters of the sensor).

In an advantageous embodiment, the laser protection system is preferably arranged in a laser housing. The laser source is additionally also arranged in the laser housing. The laser source is preferably designed as a solid-state laser.

In an advantageous embodiment of the laser protection system, the sensor is arranged in a beam direction of the laser beam on a rear side of the optical element, wherein the beam direction is directed onto the optical element. Due to the direct spatial arrangement of the sensor on the rear side of the optical element, the sensor detects quickly and with high accuracy whether the laser beam shines through the rear side of the optical element and therefore shines through the optical element from its front side to its rear side. The beam direction relates in particular to an (extended) beam direction of the laser beam in a section of the beam path of the laser beam between the optical element and a further optical element, which is closest adjacent to the optical element in the beam path and is upstream from the optical element. In particular, the sensor is applied to the rear side of a mirror, wherein this rear side can comprise one or more layers.

In an alternative embodiment of the laser protection system, the sensor is arranged behind the optical element in a beam direction of the laser beam and spaced apart from the optical element, wherein the beam direction is directed onto the optical element. The positioning of the sensor can thus take place comparatively flexibly, for example, in order to effectuate a better signalling connection to a detector unit.

In the beam direction of the laser beam, which is directed onto the optical element, an absorber is arranged between the sensor and the optical element in a preferred variant of the laser protection system. The absorber absorbs a proportion of the laser radiation which is transmitted by the optical element, for example, due to different frequencies of a laser pulse. The absorber also absorbs radiation which the optical element emits in the direction of the sensor due to its heating as a result of the irradiation by the laser radiation. The sensor is thus protected. In particular, the sensor and the optical element are arranged directly on the absorber. The absorber is designed, for example, as a copper plate, wherein the absorber is preferably thermally connected to a cooling system for cooling.

In a further embodiment, the laser protection system comprises an EUV light source in the beam path of the laser beam. The optical element is arranged in the beam path of the laser beam between the laser source and the EUV (extreme ultraviolet radiation) light source or behind the EUV light source, in order to guide the laser beam in a desired direction. The sensor reliably indicates whether the laser beam penetrates the optical element and therefore does not pass through the desired beam path. The laser pulses generated by the laser source are preferably used for irradiating the EUV light source, in particular of tin droplets.

In one advantageous embodiment, the laser protection system comprises a switching element for switching off the laser beam if the electrical resistance of one of the conductor tracks of the sensor exceeds a predetermined monitoring value, in particular if the current flow through one of the conductor tracks of the sensor is interrupted. The switching element advantageously prevents harmful decoupling of the laser beam into the surroundings of the optical element by switching off the laser beam.

It is possible for the above-mentioned features and the features mentioned below to be used individually by themselves or for multiple features to be used in any desired combinations. The embodiments shown and described should not be understood as an exhaustive list, but rather they have an exemplary character.

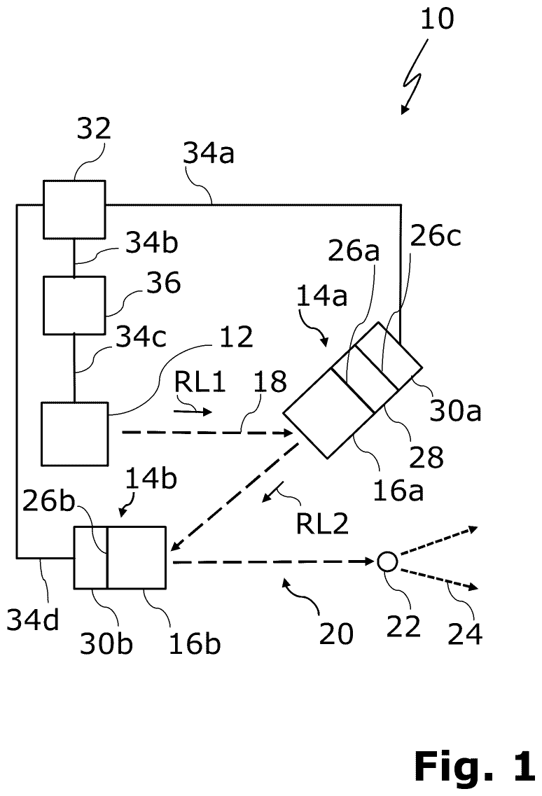

FIG. 1 schematically shows a laser protection system 10 having a laser source 12 and a first arrangement 14a and a second arrangement 14b for protecting the surroundings of a first and second optical element 16a, 16b from a laser beam 18 from the laser source 12. The two arrangements 14a, 14b can be provided alternatively or together. The optical elements 16a, 16b are designed as mirrors and are arranged in the beam path 20 of the laser beam 18 from the laser source 12. The laser beam 18 is guided by the optical elements 16a, 16b to an EUV light source (“target”, in particular in the form of a tin droplet) 22, which emits EUV radiation 24.

To absorb laser radiation transmitted by the first optical element 16a, an absorber 28, for example, in the form of a copper plate, is located in a first direction RL1 of the laser beam 18 on the rear side 26a of the first optical element 16a. A first sensor 30a is arranged on the rear side 26c of the absorber 28 at a distance to the first optical element 16a, in order to detect laser radiation which undesirably shines through both the first optical element 16a and the absorber 28. The first sensor 30a is positioned behind the first optical element 16a in the beam direction RL1 of the laser beam 18. A current flows through the first sensor 30a, wherein electrical parameters of the first sensor 30a change when the laser beam 18 strikes the first sensor 30a.

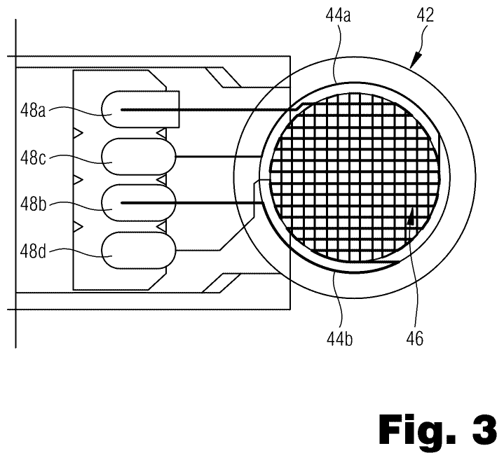

The change of the electrical parameters and therefore of the current flow can be detected by a detector unit 32, which is connected to the first sensor 30a by a first signal channel 34a. In the event of a change of the parameters which is outside a predetermined monitoring range, the detector unit 32 outputs a signal through a second signal channel 34b to a switching unit 36, in order to switch off the laser source 12 and thus the laser beam 18 via a third channel 34c. This relates in particular to the electrical resistance of a conductor track of the first sensor 30a (see FIG. 3), through which the current flows. The laser beam 18 is thus prevented from irradiating an undesired point in the surroundings of the first optical element 16a and causing damage.

The laser beam 18 is guided by the first optical element 16a to the second optical element 16b, which is designed as part of the second arrangement 14b for laser protection. A second sensor 30b is located on the rear side 26b of the second optical element 16b (in a second beam direction RL2 of the laser beam 18 toward the second optical element 16b), in order to detect whether the laser beam 18 undesirably penetrates the second optical element 16b. A current flows through the second sensor 30b, like the first sensor 30a. The electrical parameters of the second sensor 30b change when the laser beam 18 strikes the second sensor 30b after penetrating the second optical element 16b. This change is signalled by a fourth signal channel 34d to the detector unit 32, which in turn prompts switching off of the laser source 12 if these changes exceed a monitoring range.

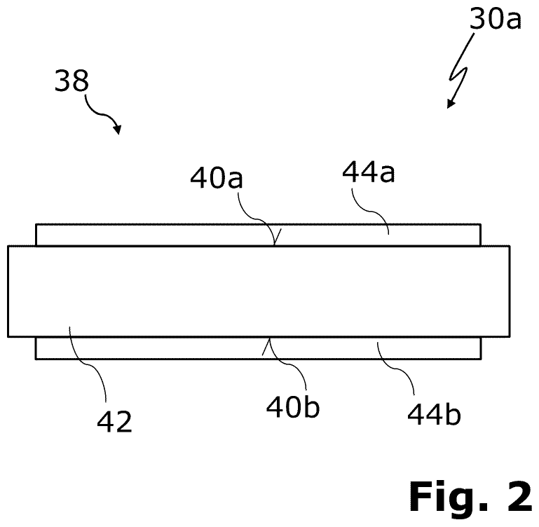

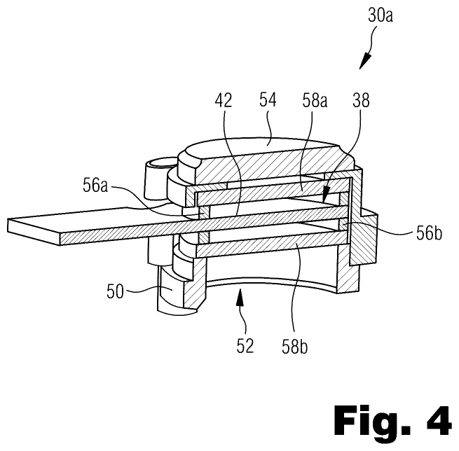

FIG. 2 schematically shows a cross section through a detection area 38 (cf. FIG. 4) of a sensor, here the sensor 30a by way of example. A first conductor track 44a, the electrical parameters of which change when it is irradiated by the laser beam 18 (see FIG. 1), is arranged on a first side 40a of a substrate 42 of the sensor 30a. To increase the detection reliability, a second conductor track 44b is arranged on a second side 40b of the substrate 42, which is opposite to the first side 40a. The conductor tracks 44a, 44b can be connected in parallel or in series. The substrate 42 can be designed as part of an optical element 16a, 16b (see FIG. 1), for example, on the rear side of a mirror. The detection area 38 in particular comprises the substrate 42 and the conductor tracks 44a, 44b.

FIG. 3 schematically shows a top view of the substrate 42 and the conductor tracks 44a, 44b of a sensor, the sensor 30a here by way of example. The first conductor track 44a is guided with a meandering shape 46 along the first side 40a of the substrate 42 (see FIG. 2) from a first electrical connection 48a to a second electrical connection 48b. Current can be conducted through the first conductor track 44a by the first and second connection 48a, 48b, in order to measure a change of the electrical parameters of the first conductor track 44a. Accordingly, the second conductor track 44b is guided with a meandering shape 46 along the second side 40b of the substrate 42 (see FIG. 2) from a third electrical connection 48c to a fourth electrical connection 48d. Current can be conducted through the second conductor track 44b by the third and fourth connection 48c, 48d, in order to measure a change of the electrical parameters of the second conductor track 44b. The first and the second conductor track 44a, 44b are at an angle, in particular a right angle to one another. In particular, sections of the conductor tracks 44a, 44b (for example, sections of equal length) corresponding to one another extend at a right angle to one another.

FIG. 4 shows a cross section through a sensor, the sensor 30a here by way of example. The substrate 42 having the conductor tracks 44a, 44b (see FIG. 3) is enclosed by a housing 50 for protection, wherein the housing 50 has an opening 52 at a lower end and a cover 54 at an upper end. A laser beam 18 (see FIG. 1) can penetrate through the opening 52 into the housing 50 in order to irradiate the substrate 42. Sealing rings 56a, 56b are applied on both sides of the substrate 42, on which protective glasses 58a, 58b are arranged, in order to additionally protect the conductor tracks 44a, 44b on the substrate 42. In particular, the protective glasses 58a, 58b and the housing 50 surround the detection area 38 of the sensor. The protective glasses 58a, 58b moreover reduce a flow of particles into the surroundings of the sensor 30a when the substrate 42 is struck by a laser beam 18. The protective glasses 58a, 58b are preferably transmissive for the radiation of a laser beam 18 used in the laser protection system 10.

As described above, embodiments of the invention relate to an arrangement 14a, 14b for laser protection having an optical element 16a, 16b for reflecting and/or absorbing a laser beam 18 and a sensor 30a, 30b, which is arranged on the optical element 16a, 16b or spaced apart from the optical element 16a, 16b in order to detect the laser beam 18 shining through the optical element 16a, 16b. The sensor 30a, 30b comprises a substrate 42 having a conductor track 44a, 44b arranged on the surface of the substrate 42, wherein the conductor track 44a, 44b is guided in a labyrinth shape.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Laser protection system
12 Laser source
14a,b Arrangements for laser protection
16a,b Optical elements
18 Laser beam
20 Beam path
22 EUV light source
24 EUV radiation
26a-c Rear sides of the components
28 Absorber
30a,b Sensors
32 Detector unit
34a-d Signal channels
36 Switching unit
38 Detection area of the sensor
40a,b Sides of the substrate
42 Substrate
44a,b Conductor tracks
46 Meandering shape
48a-d Connections
50 Housing
52 Opening
54 Cover
56a,b Sealing rings
58a,b Protective glasses
RL1,2 Directions of the laser beam

1. An arrangement for laser protection, the arrangement comprising:
a reflecting and/or absorbing optical element configured to be irradiated by a laser beam; and
a sensor comprising a substrate and a meandering electrical first conductor track arranged on a first side of the substrate;
wherein the sensor is arranged indirectly or directly on the optical element or is configured to detect a damage to the optical element by the laser beam.

2. The arrangement according to claim 1, wherein the sensor further comprises a meandering electrical second conductor track, wherein the first conductor track and the second conductor track are perpendicular to one another.

3. The arrangement according to claim 2, wherein the second conductor track is arranged on a second side of the substrate, the second side being opposite to the first side of the substrate.

4. The arrangement according to claim 2, wherein the first conductor track and the second conductor track are connected in parallel to one another.

5. The arrangement according to claim 2, wherein the first conductor track and the second conductor track are connected in series.

6. The arrangement according to claim 1, wherein the sensor is arranged directly on the optical element.

7. The arrangement according to claim 6, wherein the substrate of the sensor is formed as a part of the optical element.

8. The arrangement according to claim 1, wherein the sensor comprises a housing that encloses at least the first conductor track and the substrate.

9. A laser protection system, comprising an arrangement for laser protection according to claim 1, and a laser source for emitting the laser beam, wherein the optical element is arranged in a beam path of the laser beam.

10. The laser protection system according to claim 9, wherein the sensor is arranged on a rear side of the optical element in a beam direction of the laser beam, wherein the beam direction is directed onto the optical element.

11. The laser protection system according to claim 9, wherein the sensor is arranged behind the optical element and spaced apart from the optical element in a beam direction of the laser beam, wherein the beam direction is directed onto the optical element.

12. The laser protection system according to claim 11, wherein an absorber is arranged between the sensor and the optical element in the beam direction of the laser beam.

13. The laser protection system according to claim 9, further comprising an EUV light source in the beam path of the laser beam.

14. The laser protection system according to claim 9, further comprising a switching element for switching off the laser beam if the electrical resistance of one of the conductor tracks of the sensor exceeds a predetermined monitoring value.

15. The laser protection system according to claim 9, further comprising a switching element for switching off the laser beam if the current flow through one of the conductor tracks of the sensor is interrupted.
